(19) United States
(12) Patent Application Publication
(10) Pub. No.: US 2009/0065448 A1
(43) Pub. Date: Mar. 12, 2009

(54) Slurry Handling and Separating System

(76) Inventor: Daniel Schedler, Grafton, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/243,970

(22) Filed: Oct. 1, 2008

Related U.S. Application Data
(63) Continuation-in-part of application No. 12/020,570, filed on Jan. 27, 2008.
(60) Provisional application No. 60/898,060, filed on Jan. 29, 2007.

(51) Int. Cl. C02F 11/12; C02F 11/04; C02F 103/20

(52) U.S. Cl. 210/770; 210/248

(57) ABSTRACT

A slurry handling system comprised of: at least one generation point at which a slurry is generated; a receiver tank adapted to at least temporarily accumulate the slurry; at least one separator; at least one screw press to further remove water from the slurry; a reservoir adapted to accumulate water extracted from the slurry; conduits connecting each component and providing a path for the slurry to move through; and conveying members to move the slurry along the conduits. One embodiment of the separator is comprised of: a drip pan; at least one separation screen on the drip pan; a drip skirt behind the separation screen; and a solids trough below the separation screen, such that as the slurry passes over each separation screen, at least a portion of the water from the slurry passes through the separation screen and temporarily collects in the drip pan. The remainder of the slurry passes over each separation screen and into the solids trough, where the slurry can be accumulated and used. Alternate embodiments of the separator can include a vibration mechanism and/or a cleaning system.

### CROSS-REFERENCE To RELATED APPLICATION

This application claims the benefit of and priority to U.S. provisional application Ser. No. 60/898,060, filed on Jan. 29, 2007 and U.S. application Ser. No. 12/020,570 both incorporated in their entirety.

### FIELD OF INVENTION

This invention relates generally to the field of slurry handling, and in particular to the field of an apparatus and method for separating water from the solid content of a slurry.

### BRIEF DESCRIPTION OF THE DRAWINGS

FIG. 1 shows one embodiment of a slurry handling system.

FIG. 2 shows a top perspective view of an exemplary barn and one embodiment of how manure is removed from the barn.

FIG. 3a shows a top perspective view of one embodiment of a separator.

FIG. 3b shows a side view of an alternate embodiment of a separator having a rounded drip pan and a pivotal support.

### DETAILED DESCRIPTION OF EMBODIMENTS OF THE INVENTION

For the purpose of promoting an understanding of the present invention, references are made in the text hereof to embodiments of a slurry handling and separating system, some of which are depicted in the drawings. It should nevertheless be understood that no limitations on the scope of the invention are thereby intended. Moreover, it should be understood that, while the system is shown and described with respect to a manure handling system in which a portion of the liquid content is separated from the solid component of a manure slurry, the system and apparatus can also be used to separate the liquid and solid components of a slurry created in the wood pulp, mining, tanning, excavation, textile, and marine industries as non-limiting examples.

One of ordinary skill in the art will readily appreciate that modifications such as those involving the number of components, positioning of the components relative to one another, materials or size of the components, and the inclusion of additional elements, do not depart from the spirit and scope of the present invention. Some of these possible modifications are mentioned in the following description. In addition, in the embodiments depicted herein, like reference numerals refer to identical or substantially similar structural elements in the various drawings. Therefore, specific details disclosed herein are not to be interpreted as limiting, but rather as a basis for the claims and as a representative basis for teaching one skilled in the art to employ the present invention in virtually any appropriately detailed system, structure, or manner.

Moreover, the term “substantially” or “approximately” as used herein may be applied to modify any quantitative representation that could permissibly vary without resulting in a change in the basic function to which it is related. For example, one embodiment of a separator is disclosed herein as including three (3) separation screens positioned at angles to one another and a drip skirt generally parallelly disposed behind the separation screens. The drip skirt might permissibly be somewhat non-parallelly disposed behind the separation screens and still be within the scope of the invention if its functionality is not materially altered.

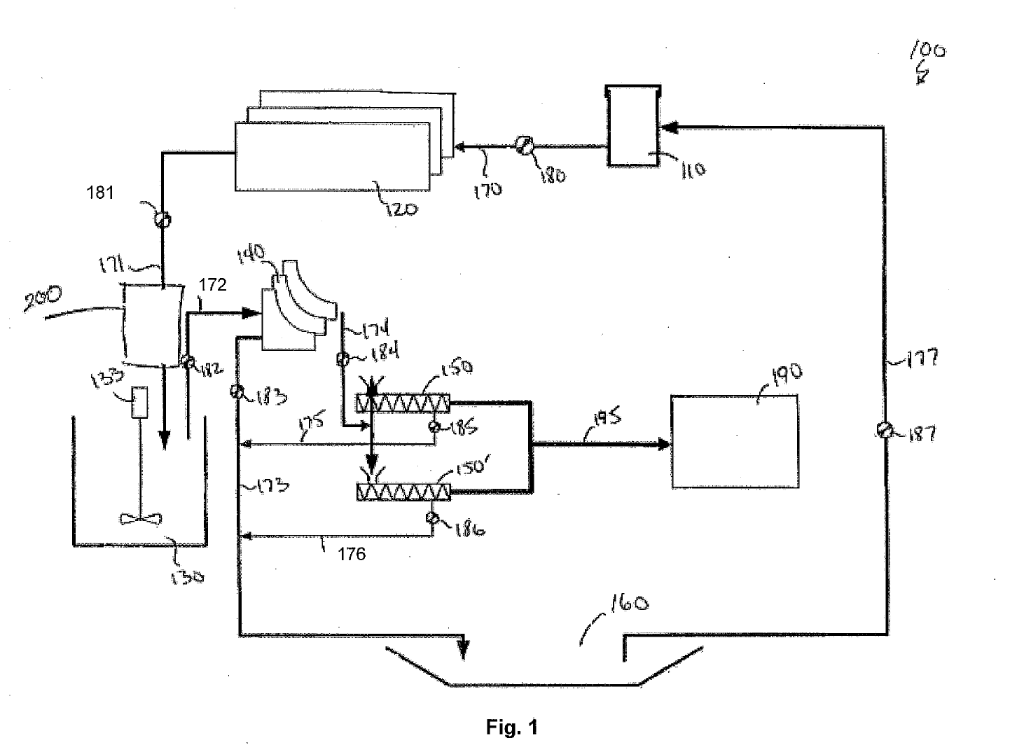

Referring to the drawings, FIG. 1 shows one embodiment of slurry handling system 100, for use on a farm, in which the solid component of the slurry generated is animal manure. In the embodiment shown, slurry handling system 100 is comprised of flush tank 110, three (3) barns 120, receiver tank 130, three (3) separators 140, two (2) screw presses 150, reservoir 160, a series of conduits 170-177 connecting each component of slurry handling system 100, and eight (8) conveying members 180-187. It should be understood that the number of barns 120 is not intended to be limiting. That is, system 100 can be used in an embodiment of system 100 in which any number of barns 100 are included, including one (1). In addition, as provided supra, the use of system 100 for separating at least a portion of the solid manure from the liquid component of a slurry is only one example of the uses to which system 100 is applicable.

In the embodiment of slurry handling system 100 shown in FIG. 1, flush tank 110 draws liquid from reservoir 160 (as will be discussed infra) and passes it through one (1) or more barns 120, in which animal manure accumulates, to flush the manure through barns 120. In one embodiment, flush tank 110 periodically passes water through barns 120 according to a timer. However, in alternate embodiments, flush tank 110 can pass water through barns 120 continuously, a worker can use a hose to manually flush the manure through barns 120, or a “scraper” (for example, a Bobcat ®) can be used to manually push the manure through barns 120.

In the embodiment shown, a single conduit 170 and a single conveying member 180 draw water from flush tank 110 and bring it to barns 120. However, one of ordinary skill in the art will recognize that multiple conveying members 180 could also be used for each conduit 170 and that multiple conduits 170 could be used, either one (1) for each barn 120 or multiple conduits 170 per barn 120, depending on the amount of water required to pass through barns 120. In addition, gravity flow could be used to convey the slurry between flush tank 110 and barns 120 or between any or all of the components of slurry handling system 100. In an embodiment using gravity flow, slurry handling system 100 would include fewer or zero (0) conveying members 180-187. That is, slurry handling system 100 could use gravity flow between some components, e.g. between barns 120 and receiver tank 140 as well as between screw presses 150 and reservoir 160, but rely on conveying members 180-187 to convey the slurry between the remaining components. In the embodiment shown, handling system 100 includes aneroebic digester 200 which is a device commonly known in the art for breaking down micro-organisms in manure. In the embodiment shown, separators screen 140 will positioned to accommodate the incorporation of anerobic digester 200 into the system.

As used herein, “conduit” refers either to a pipe, circular or other shape, as well as to a channel, also of any shape. In the embodiment shown in FIG. 1, conduit 170 is PVC piping, but in alternate embodiments, conduit 170 could be galvanized steel, fiberglass, concrete, clay, or schedule 40 or 80 PVC, which are all acceptable and functional alternate materials. For drier materials (either drier sections of slurry handling system 100 or alternate systems as provided supra), electrically-, pneumatically-, or hydrauliclly-driven plastic or steel augers, or rubber or steel belts can also be used convey the material between the components of slurry handling system 100. In addition, transfer plumbing or troughs can be used or any alternate conduit 170-177 that can be sized to meet flow and pressure requirements can be used in slurry handling system 100, including any combination thereof. In the embodiment of slurry handling system 100 shown, all conduits 170-177 are the same, but in alternate embodiments, one conduit 170-177 could be of one type and another conduit 170-177 in another section of slurry handling system 100 be of a different type.

Also as used herein, “conveying member” refers to a pump or any other way of moving the slurry or its components along conduits 170-177. In the embodiment shown, conveying member 182 is a Yaskawa (™) variable speed frequency drive with a Honeywell PID controller to control the flow rate to between one hundred (100) and four hundred (400) gallons per minute, and conveying members 180, 181, and 183-187 are each a 15 Hp Vaughan (™) copper pump with a Yaskawa (™) variable speed frequency drive. However, in alternate embodiments of slurry handling system 100, conveying members 180-187 could alternately be a centrifugal pump, a trash pump, an air diaphragm pump, a progressive cavity pump, an Archimedes screw pump (to avoid shearing the material before screening), gravity flow, or any other pump capable of moving a slurry along conduits 170-177, including combinations thereof. The exact conveying member 180-187 will depend on the slurry to be moved considering the pH, viscosity, density, volume, and other characteristics of the slurry. In the embodiment shown, one conveying member 182 is of one type and the remaining conveying members 180-181, 183-187 are a different type. In alternate embodiments of slurry handling system 100, all conveying members 180-187 can be the same, or, as with the embodiment shown the various conveying members 180-187 can be any number of different pumps.

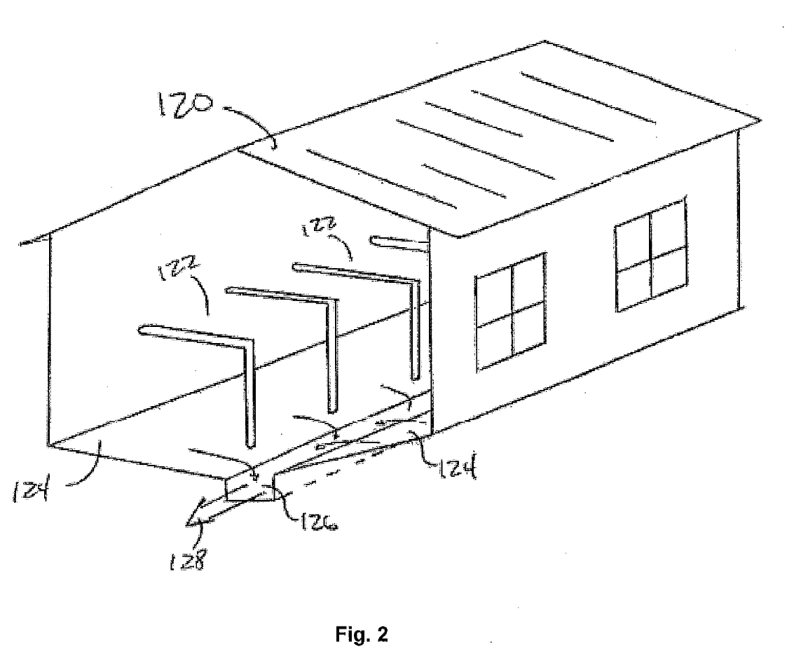

In the embodiment shown, there are three (3) barns into which water from flush tank 110 flows. In the embodiment shown, conveying member 180 delivers water to barns 120 via conduit 170. However, in an alternate embodiment, gravity flow can also be used. FIG. 2 shows a top perspective view of one (1) barn 120 and how the manure is removed therefrom. Each stall 122 is pitched (as designated by number 124). As the manure is released, it accumulates in alley 126 where it is removed from barn 120 by the water drawn from flush tank 110 as discussed supra and as indicated by arrow 128. In an alternate embodiment of slurry handling system 100, also as discussed supra, a worker can manually remove the manure from alley 126 using a hose or a scraper can be used to manually push the manure through barn 120. In a further alternate embodiment of barn 120 and slurry handling system 100, barn 120 does not contain pitched floor 124, but is instead flat. The entire floor would then have to be scraped or manually cleaned of the manure, typically by scraping the manure into alley 126.

In addition, as stated supra, slurry handling system 100 can be used in alternate industries. Barns 120 are just one generation point, i.e., a point or area at which the manure slurry is created or accumulated. In other industries, the slurry would not be a manure slurry, but some other type of slurry.

Referring again to FIG. 1, after the manure is removed from barn or barns 120, either through flushing or scraping, the slurry accumulates in receiver tank 130. In the embodiment shown, the slurry is conveyed from barns 120 using conduit 171 and conveying member 181 of the types provided supra. Again, the embodiment shown and described herein uses only one (1) conduit 171 and one (1) conveying member 181, but could also use multiple conduits 171 and/or conveying members 181, depending on the needs of slurry handling system 100. The slurry is mixed by receiver tank mixer 133 to keep the slurry from settling. By accumulating the slurry in receiver tank 130 rather than passing it directly to separators 140, discussed in greater detail infra, receiver tank 130 ensures a constant flow of the slurry to separators 140, allowing for periodic barn flushing discussed supra, rather than an embodiment of slurry handling system 100 in which barns 120 must be continuously flushed. Figure one further illustrates the overflow component of the system, consising of overflow tank 160 and weir 161. The wier commonly known in the art that acts as a device to distribute and level and flow of a fluid. In the embodiment shown the weir is a cylindrical bar over which water flows, but other embodiment the bar may flat, rectangular or any other shape which operates to level the flow of water.

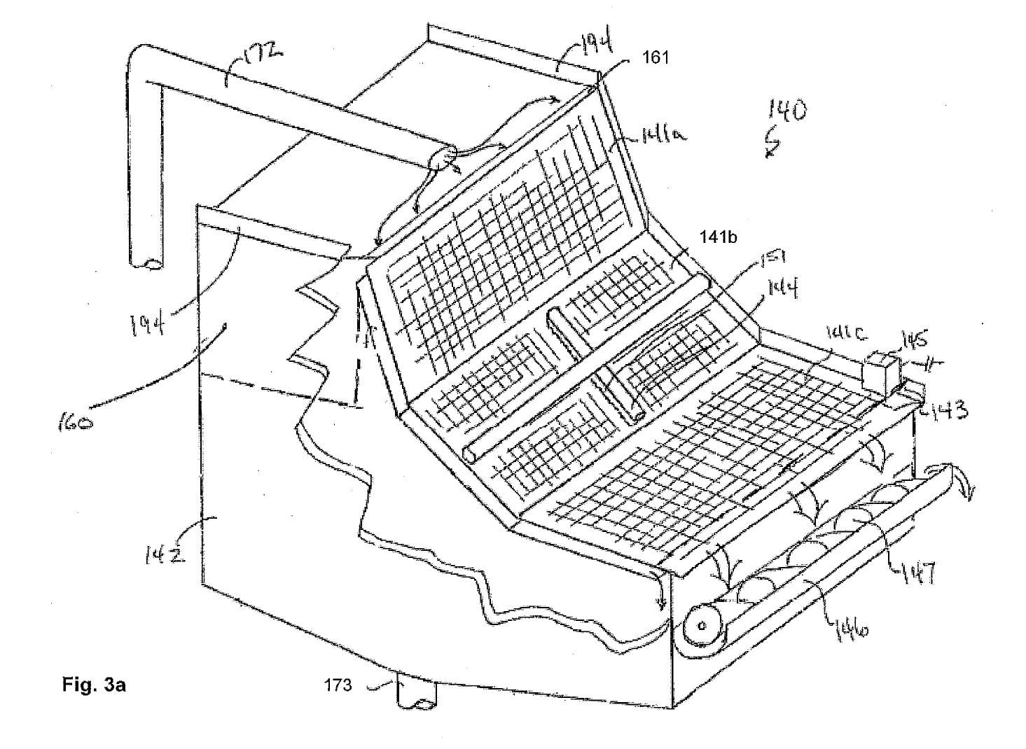

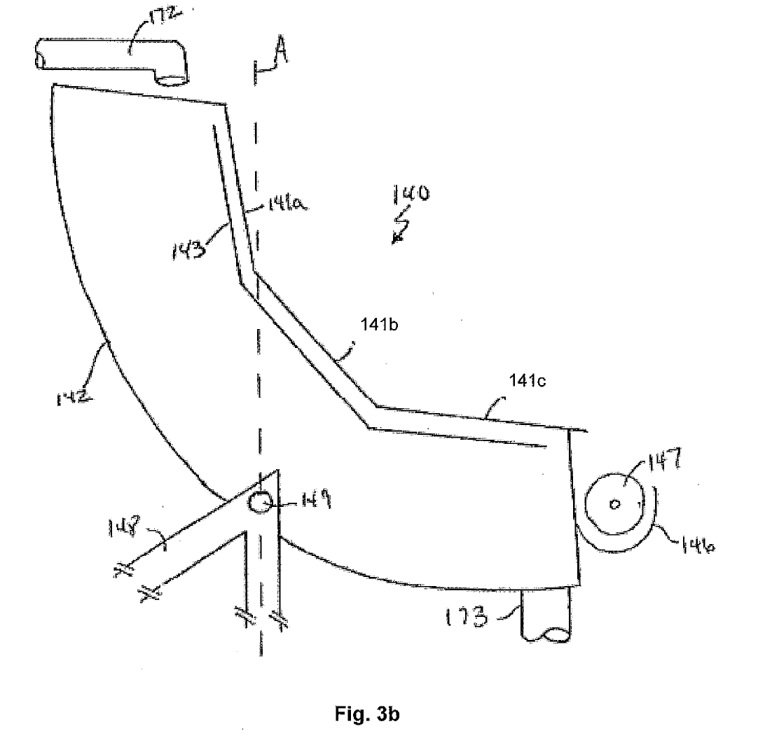

Also visible in the embodiment of slurry handling system 100 shown in FIG. 1 are separators 140. In the embodiment shown, there are three (3) separators 140. However, any number of separators 140 could be employed, including one (1). FIG. 3a shows a top perspective view of one embodiment of one (1) separator 140. In the embodiment of separator 140 shown, separator 140 is comprised of: three (3) pitched separation screens 141a, 141b, and 141c, over which the manure slurry passes; drip pan 142, which catches the water extracted from the slurry; drip skirt 143 which prevents the water filtrate that wicks along the back side of separation screens 141a, 141b, and 141c from running off the lowermost point and re-joining the solid and is generally the same shape as and positioned behind separation screens 141a, 141b, and 141c; scrubber 144, which cleans pitched separation screens 141a, 141b, and 141c; vibrator 145 which vibrates separation screens 141a, 141b, and 141c to enhance the separation process; and solids trough 146, into which the solids fall to be directed away from separator 140. As provided supra, in an embodiment of the slurry handling system in which a receiver tank (not shown in FIG. 3) is employed, the slurry is delivered from the receiver tank to separator 140 via conduit 172, and the extracted water is eliminated from separator 140 along conduit 173. Conduit 173 can lead to the reservoir (not shown; as described supra), to the receiver tank to capture any overflow from separator 140, to a separate reciever such as a sewer line or reservoir for collection and further treatment or any combination thereof. Separator 140, in the embodiment shown, is made of stainless steel, but can alternately be made of aluminum, sheet metal, brass, steel, carbon steel, fiberglass, plastic, or any other material that is sufficiently durable and corrosion-resistent, including combinations thereof.

In the embodiment of separator 140 shown in FIG. 3a, there are three (3) separation screen sections 141a, 141b, and 141c, which collectively form a “separation screen.” However, it should be understood that any number of pitched separation screen sections 141a, 141b, and 141c could be employed to form the separation screen, and that a single screen with two (2) bends to give the effect of three (3) separation screen sections 141a, 141b, and 141c (or any other number), or a single staight separation screen are all alternate embodiments of separator 140 intended to be included within the spirit and scope of the invention.

Separation screen sectionss 141a, 141b, and 141c are each pitched at a different angle. The pitch of each separator screen section 141a, 141b, 141c affects the flow rate of the slurry across each separator screen section 141a, 141b, 141c and therefore the ability to remove liquid from the slurry. That is, the slurry moves fastest across first separator screen section 141a as the bulk of the water is separated from the slurry and passes through first separator screen section 141a. Likewise, the slurry moves slowest across third separator screen section 141c as more time is spent on third separator screen section 141c to remove water from the drier slurry. As the slurry passes over each separation screen section 141a, 141b, and 141c, the solid does not pass through, but the liquid component is allowed to pass through separation screen sections 141a, 141b, and 141c. Thus, the liquid component is separated from the solid component of the slurry. In the embodiment shown, each separation screen section 141a, 141b, and 141c is made of stainless steel wedge wire, but could alternately be meshed wired. In an alternate embodiment, separation screen sections 141a, 141b, and 141c could be made of aluminum, sheet metal, brass, steel, carbon steel, plastic, or any other material that is sufficiently durable and corrosion-resistent, including combinations thereof.

Also visible in the embodiment of separator 140 shown in FIG. 3a is drip pan 142. Drip pan 142 collects the water extracted from the slurry that is passed over and through separation screen sections 141a, 141b, and 141c. As provided supra, the collected water is deliverd to the reservoir and/or to the receiver tank via conduit 173. In the embodiment shown, drip pan 142 is made of stainless steel, but could alternately be made of fiberglass, carbon steel, steel, plastic, aluminum, sheet metal, brass, or any material that is sufficiently durable and corrosion-resistant, including combinations thereof.

Also visible in the embodiment of separator 140 shown in FIG. 3a is drip skirt 143. Drip skirt 143 directs the water extracted from the slurry that is passed over separation screen sections 141a, 141b, and 141c to drip pan 142. As provided supra, drip skirt 143 prevents the water filtrate that wicks along the back side of separation screen sections 141a, 141b, and 141c from running off the lowermost point of separation screen section 141c and re-joining the solid. In the embodiment shown, drip skirt 143 is made of stainless steel, but could alternately be made of fiberglass, carbon steel, steel, plastic, aluminum, sheet metal, brass, rubber, or any material that is sufficiently durable and corrosion-resistant, including combinations thereof. In order to properly prevent the water filtrate from wicking along the back side of separation screen sections 141a, 141b, and 141c, drip skirt 143 is shaped substantially the same as separation screens 141a, 141b, and 141c and positioned approximately twelve inches (12″) behind separation screen sections 141a, 141b, and 141c. However, it should be understood that drip skirt 143 can be an alternate distance behind separation screens 141a, 141b, and 141c as long as it functions to prevent extracted water from wicking along the back of separation screen sections 141a, 141b, and 141c and mixing back with the dried slurry. In addition, in an alternate embodiment (not shown), drip skirt 143 is not a separate element, but integrated directly into the body of separator 140.

Also visible in the embodiment of separator 140 shown in FIG. 3a is scrubber 144, one embodiment of a cleaning system. Scrubber 144 cleans separation screen sections 141a, 141b, and 141c by removing any slurry that sticks to separation screen sections 141a, 141b, and 141c. In the embodiment shown, scrubber 144 moves back and forth horizonally. Scrubber 144 is driven pneumatically and one or more limit switches (not shown) triggers scrubber 144 to stop and change directions. The cleaning system is comprised of a corrosion-resistant metal frame with a number of squeegees or brushes 151 mounted to cover separation screen section 141b and apply pressure sufficient to remove any slurry build up on separation screen 141b. The sweep speed of the cleaning system is controlled by air pressure and flow. In the embodiment of separator 140 shown in FIG. 3a, there is a single scrubber 144 moving horizontally across separation screen section 141b. It should be understood that scrubber 144 could move vertically, that separator 140 could have one (1) scrubber 144 for each separation screen section 141a, 141b, and 141c, and/or that more than one scrubber 144 could be used for each separation screen section 141a, 141b, and 141c. In addition, in alternate embodiments of the cleaning system, the frame can be made of fiberglass, plastic, or any other sufficiently durable and corrosion-resistant material, that scrubber 144 could instead have one or more squeegie blades, the cleaning system could alternately be operated electrically, or hydraulically, and that the sweep speed could alternately be controlled by a flow or variable speed frequency drive or one or more speed reducing sieves.

In one alternate embodiment of separator 140, separation screen sections 141a, 141b, and 141c are also vibrated using a vibration mechanism to aid in the process of separating the water from the solid in the manure slurry according to the system of the instant invention. Vibrator 145 is one example vibrating mechanism and is pneumatically operated and is positioned above separation screen section 141c. In alternate embodiments, vibrator 145 can be mounted underneath or higher up on separation screen section 141c. In the embodiments in which vibrator is mounted to an edge of separation screen section 141c, the edge should be stiffened with a support, and in the embodiment in which vibrator 145 is mounted to the center of separation screen section 141c, a strengthening bar should be mounted to the back side of separation screen section 141c, horizontally and along the center or substantially adjacent to the position of vibrator 145. In addition, in an alternate embodiment of separator 140, vibrator can be electrically or hydraulically operated.

It should be understood that although the vibrating mechanism has been shown with respect to vibrating only separation screen section 141c, separation screen sections 141a and 141b can each also include a separate vibrating mechanism in addition to or instead of the vibrating mechanism associated with separation screen section 141c. In the embodiment shown, because separation screen 141a, 141b, and 141c is made of a single sheet and bent to form each separation screen section 141a, 141b, and 141c, a single vibrator 145 results in all three (3) separation screen sections 141a, 141b, and 141c vibrating.

In addition, the vibrating mechanism of separator 140 could further include one or more vibration isolators (not shown) mounted on separator 140 and supporting separation screen sections 141a, 141b, and/or 141c. The vibration isolators are made of rubber or are spring supports and allow separation screen sections 141a, 141b, and 141c to move freely without having to be rigidly secured to separator 140.

Also visible in FIG. 3a is solids trough 146. After the slurry passes over each separation screen section 141a, 141b, and 141c, due to the incline of separation screen section 141c, the remaining slurry falls into solids trough 146. In addition, rails 194 help guide the slurry into solids trough 146. Thus, the slurry exits separator 140 with a significant portion of its water content having been removed. Once in solids trough 146, the slurry can then be moved to one or more presses (as described in detail infra). Separator 140 can be constructed with solids trough 146 independent of, integral with, or secured to separator 140. That is, solids trough 146 can be separate from or part of separator 140.

The slurry can be removed from solids trough 146 by any mechanism known in the art. However, in the embodiment shown in FIG. 3a, the slurry is moved laterally along solids trough 146 by auger 147 and allowed to pass through a hole (not shown) in solids trough 146 where it is moved to the one or more presses via conveying member 184 and conduit 174 (as shown in FIG. 1).

In the embodiment shown, solids trough 146 is constructed of stainless steel. However, one of ordinary skill in the art will readily appreciate that solids trough 146 could be made of any sufficiently strong, durable, and corrosion-resistant material such fiberglass, carbon steel, steel, plastic, aluminum, sheet metal, brass, rubber, or wood, including combinations thereof

It should be understood that each feature need not be in every embodiment of separator 140. For example, one embodiment of separator 140 could include scrubber 144, but separation screen sections 141a, 141b, and 141c not vibrate; separtator 140 could have a single pitched screen section 141a/b/c or a single screen with two (2) bends in it to have effectively three (3) pitches (or an alternate number of bends) and include the vibrating mechanism, but not include scrubber 144; or solids trough 146 could be eliminated and the slurry having passed separation screen sections 141a, 141b, and 141c falls directly in to a collector, as only a few examples of alternate embodiments of separator 140.

FIG. 3b shows a side view of an alternate embodiment of separator 140 with a rounded drip pan 142 and a pivotal support. The pivotal support, which reduces construction costs, is comprised of pivot support 148 and pivot pin 149, which allows the three (3) angles of pitched separation screen sections 141a, 141b, and 141c to be changed relative to vertical axis A. Although not shown, a second pivot support and pivot pin would be on the other side of drip pan 142. As with the embodiment of separator 140 shown in FIG. 3a, the slurry enters separator 140 via conduit 172, passes over separation screens 141a, 141b, and 141c, and the extracted water follows drip skirt 143, accumulates in drip pan 142, and passes either to the reservoir (not shown) or to the receiver tank (also not shown) via conduit 173.

When used as a manure separator on a farm, the solids concentration of the slurry entering the separators is approximately three percent (3%) by weight and ninety-seven percent (97%) liquid. Upon passing through separator(s) 140, the solids concentration of the thickened sludge is approximately twelve percent (12%) solids and eighty-eight percent (88%) liquid, reducing the amount of water that has to be removed from the slurry by presses 150, discussed infra, which further increase the solid concentration, or by other means. The extracted liquid is then deposited in reservoir 160, as can be seen in FIG. 1, or other locations as provided supra.

Referring again to FIG. 1, the extracted liquid is moved by conveying member 183 and passed along conduit 173. In the embodiment shown, there is a single conduit 173 and conveying member 183. However, a single conveying member 183 and conduit 173 are shown only for simplicity. In alternate embodiments of slurry handling system 100 could employ multiple conveying members 183 and/or conduits 173 could be employed.

The partially dried manure slurry is then transferred to two (2) screw presses 150, 150′ by conveying member 184 and conduit 174. However, it should be understood that any number of screw presses 150, 150′ could be employed, including a single screw press 150. It should also be understood that a single conveying member 184 and conduit 174 are shown for simplicity, but multiple conveying members 184 and/or conduits 174 could be employed, depending on the needs of slurry handling system 100.

In the embodiment of slurry handling system 100 shown in FIG. 1, screw presses 150, 150′ further remove liquid from the slurry. Each screw press 150, 150′ has a rotating helical shaft or auger surrounded by screens. The slurry is deposited in a feed hopper at one end of the augers. As each shaft rotates, the slurries are pushed and turned over along the auger. As the material moves along, water passes through the screens, thickening the material (i.e., extracting liquid). A back presser is applied to the discharge with pressure plates, further squeezing out water from the slurry. The resulting sludge has a content of approximately sixty-five percent (65%) water and thirty-five percent (35%) solids. In the embodiment shown, Meri (™) Mini Presses are used, but alternate screw presses 150 known and used in the art could be used.

In the embodiment shown, as provided supra, the extracted liquid is delivered to reservoir 160 from each screw press 150, 150′ along conduit 175 and conduit 176, respectively, and moved by conveying member 185 and conveying member 186, respectively, and each enters conduit 173 before being deposited in reservoir 160. However, in alternate embodiments of slurry handling system 100, conduits 175 and 176 join to form a single conduit before entering conduit 173. In another embodiment, conduits 175 and 176 join to form a single conduit and deposit the slurry directly in reservoir 160. In yet another embodiment, each conduit 175 and 176 deposits the slurry directly into reservoir 160 without joining. Furthermore, a single conduit 175 and 176 is shown for each screw press 150 and 150′, and a single conveying member 185 and 186 is shown for each conduit 175 and 176. However, it should be understood that multiple conveying members 185 and 186 and/or conduits 175 and 176 could be employed, depending on the needs of slurry handling system 100.

The sludge, i.e., partially dried slurry, is transported to accumulation area 190. In the embodiment shown in FIG. 1, the sludge is transported using conveyor belt 195, but the sludge could also be transported to accumulation area by any number of methods commonly used in the art, including but not limited to an auger, gravity, and combinations thereof. Furthermore, the embodiment of slurry handling system 100 show in FIG. 1 has one (1) conveyor belt 175 for transporting the sludge from both screw presses 150 and 150′. However, slurry handling system 100 could alternately employ one (1) conveyor belt 175 for the sludge from each screw press 150 and 150′.

Also visible in FIG. 1 is reservoir 160 which is a natural or artificial pond or lake or a lagoon used for the storage and regulation of water and is particularly useful in a manure handling system. As discussed supra, conveying member 187 draws liquid from reservoir 160 and the liquid is passed along conduit 177 to deposit it in flush tank 110, as discussed supra. Moreover, in embodiments of slurry handling system 100 in which a worker uses a hose to manually flush manure through barns 120 or a scraper is to manually push the manure through barns 120, conveying member 187 and conduit 177, as well as flush tank 110, may not be necessary. Reservoir 160 can further include one or more pumps (not shown) which function as an aeration system.

While the slurry handling system has been shown and described with respect to several embodiments in accordance with the present invention, it is to be understood that the same is not limited thereto, but is susceptible to numerous changes and modifications as known to a person skilled in the art, and it is intended that the present invention not be limited to the details shown and described herein, but rather cover all such changes and modifications obvious to one of ordinary skill in the art. Moreover, as provided supra, although the slurry handling system has been shown an described with respect to a manure slurry handling system, it should be understood that the system could also be employed to separate the water and solid components of slurries generated in the wood pulp, mining, tanning, excavation, textile and other industries.

What is claimed is:

1. A slurry separator comprised of:
at least one inclined separation screen, wherein as a slurry passes over said at least one inclined separation screen, said slurry comprised of a solids component and a liquid component, at least a portion of said liquid component from said slurry passes through said at least one inclined separation screen;
a drip pan positioned behind said separation screen; and
a drip skirt positioned between said separation screen and said drip pan.

2. The slurry separator of claim 1, wherein said screen is selected from a group comprised of a perforated screen, a plastic screen, a metal screen, a disposable screen, a chemically treated screen an expanded screen, mesh, wedge wire, filter cloth and combinations thereof.

3. The slurry separator of claim 1, which further includes an overflow tank and a weir.

4. The slurry separator of claim 1, wherein said at least one inclined separation screen is comprised of a plurality of separator sections, each separator screen section inclined at a different angle relative to one another.

5. The slurry separator of claim 1, wherein said at least one inclined separation screen is a single separation screen having at least one bend to form a plurality of separator sections, each separator screen section inclined at a different angle relative to one another.

6. The slurry separator of claim 1, wherein said separation screen further includes a vibration mechanism functionally engaging at least one of said at least one inclined separation screen, said vibration mechanism of a type selected from a group comprised of pneumatically-operated, electrically-operated, and hydraulically-operated or any combination thereof.

7. The slurry separator of claim 6, wherein said vibration mechanism is further comprised of at least one vibration isolator, said at least one vibration isolator supporting said at least one inclined separation screen, said at least one vibration isolator selected from a group comprised of a rubber, spring support, shock absorbers, padding material, air filled bag, liquid filled bag or gas filled bag, impact absorbing material or any combination thereof.

8. The slurry separator of claim 1, wherein said at least one separator further comprises a cleaning system, said cleaning system comprised of a scrubber on a frame, at least one limit switch, and a driver to control movement of said scrubber.

9. The slurry separator of claim 1, wherein said scrubber is selected from a group comprised of a squeegee, pad, absorptive material, abrasive material, and a brush, and said driver operated electrically, hydraulically, or pneumatically.

10. The slurry separator of claim 1, wherein said at least one separator is further comprised of at least one pivot support and at least one pivot pin, allowing a position of said at least one inclined separation screen to be changed relative to a vertical axis.

11. The slurry separator of claim 1, wherein said slurry is manure.

12. The slurry separator of claim 1, wherein said slurry is selected from a group consisting of pulp, sludge, soil, pollutants, chemical waste, a liquid composition, bio-material and combinations thereof.

13. A slurry separator comprised of:
at least one inclined separation screen, wherein as a slurry passes over said at least one inclined separation screen, said slurry comprised of a solids component and a liquid component, at least a portion of said liquid component from said slurry passes through said at least one inclined separation screen;
a drip pan positioned behind said at least one inclined separation screen;
a drip skirt positioned between said separation screen and said drip pan;
a solids trough positioned substantially below said at least one inclined separation screen, wherein a remainder of said slurry that passes over said at least one inclined separation screen collects in said solids trough, said solids trough further comprised of an opening through which said slurry passes;
a vibration mechanism functionally engaging at least one of said at least one inclined separation screen; and
a cleaning system, said cleaning system comprised of a scrubber on a frame, at least one limit switch, and a driver to control movement of said scrubber across at least one of said at least one inclined separation screen.

14. A method for treating a slurry comprising the steps of:
flushing said slurry from at least one generation point;
accumulating said slurry in a receiver tank;
drawing said slurry from said receiver tank;
passing said slurry through at least one separator to extract a first portion of a liquid component of said slurry, each of said at least one separator comprised of:
at least one inclined separation screen;
a drip skirt positioned behind said at least one inclined separation screen;
a drip pan positioned below said drip skirt;
a solids receiving area positioned substantially below said at least one inclined separation screen, wherein as said slurry passes over each of said at least one inclined separation screen, said first portion of said liquid component of said slurry passes through said at least one inclined separation screen and temporarily collects in said drip pan, and wherein a remainder of said slurry passes over said at least one inclined separation screen and into said solids receiving area.

15. The method of claim 14 which further includes the step of processing said slurry using an anaerobic digester.

16. The method of treating slurry of claim 14 in which said solids receiving area is a device selected from a group consisting of a trough, receptacle, a moving receptacle, a ground collection area, a chute, an auger, and a conveyor.

17. The method of treating a slurry separator of claim 14 which further includes at least one screw press to draw out a second portion of said liquid component of said slurry, creating at least partially dried slurry.

18. A method of treating a slurry which further includes the step of de-watering the slurry which utilizes a mechanism selected from a group consisting of a belt press, a vacuum filter, a filter press, a centrifuge, a gravity thickener, a gravity belt, a pressure filter, a drying device, an air-flow generating device, a heat-generating, an absorbing material, and a screw press.

19. A manure slurry handling system comprised of:
at least one generation point at which a manure slurry is generated, said manure slurry having a water component and a solid component;
a flush tank, said flush tank providing a water source for cleaning said generation point;
a receiver tank adapted to at least temporarily accumulate said manure slurry;
at least one separator, each of said at least one separator comprised of:
at least one inclined separation screen;
a drip skirt positioned behind said at least one inclined separation screen;
a drip pan positioned below said drip skirt;
a solids trough positioned substantially below said at least one inclined separation screen, wherein as said manure slurry passes over each of said at least one inclined separation screen, at least a portion of said water component from said manure slurry passes through said at least one inclined separation screen and temporarily collects in said drip pan, and wherein a remainder of said manure slurry passes over said at least one inclined separation screen and into said solids trough;
at least one screw press for further removing said water component from said manure slurry;
a reservoir, said reservoir adapted to at least temporarily accumulate water extracted from said manure slurry;
a plurality of conduits connecting each component of said system and providing a path for said manure slurry to move through; and
means for conveying said water component, said solids component, and said manure slurry along said plurality of conduits.

20. The system of claim 19 which further includes an anaerobic digester.
